(19) United States
(12) Patent Application Publication
(10) Pub. No.: US 2024/0406410 A1
(43) Pub. Date: Dec. 5, 2024

(54) METHOD FOR PROCESSING VIDEO SIGNAL BY USING LOCAL ILLUMINATION COMPENSATION (LIC) MODE, AND APPARATUS THEREFOR

(71) Applicant: WILUS INSTITUTE OF STANDARDS AND TECHNOLOGY INC., Gyeonggi-do (KR)

(72) Inventors: Dongcheol KIM, Gyeonggi-do (KR); Kyungyong KIM, Gyeonggi-do (KR); Juhyung SON, Gyeonggi-do (KR); Jinsam KWAK, Gyeonggi-do (KR)

(21) Appl. No.: 18/689,066

(22) PCT Filed: Sep. 5, 2022
(86) PCT No.: PCT/KR2022/013284

§ 371 Date: Mar. 4, 2024

(30) Foreign Application Priority Data
Sep. 3, 2021 (KR) 10-2021-0117969
Aug. 19, 2022 (KR) 10-2022-0104334

(51) Int. Cl. H04N 19/157; H04N 19/117; H04N 19/132; H04N 19/176; H04N 19/186; H04N 19/42; H04N 19/70

(52) U.S. Cl. CPC H04N 19/157; H04N 19/117; H04N 19/132; H04N 19/176; H04N 19/186; H04N 19/42; H04N 19/70

(57) ABSTRACT

An apparatus for decoding a video signal comprises a processor, wherein the processor parses a first syntax element that is a general constraint information (GCI) syntax element, parses a second syntax element that indicates whether an LIC mode is available for a current sequence, and parses a third syntax element that indicates whether the LIC mode is used in a current block on the basis of a parsing result of the second syntax element.

### CROSS-REFERENCE TO RELATED APPLICATIONS

This application is a continuation of pending PCT International Application No. PCT/KR2022/013284, which was filed on Sep. 5, 2022, and which claims priority under 35 U.S.C 119 (a) to Korean Patent Application No. 10-2021-0117969 filed with the Korean Intellectual Property Office on Sep. 3, 2021, and Korean Patent Application No. 10-2022-0104334 filed with the Korean Intellectual Property Office on Aug. 19, 2022. The disclosures of the above patent applications are incorporated herein by reference in their entirety.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

An aspect of the present specification is to provide a video signal processing method and a device therefor to increase the coding efficiency of a video signal.

### Solution to Problem

The disclosure provides a video signal processing method and an apparatus therefor.

In the specification, a video signal decoding apparatus may include a processor, and the processor may parse a first syntax element that is a general constraint information (GCI) syntax element from a bitstream, may parse, based on a result of parsing the first syntax element, a second syntax element indicating whether an LIC mode is available for a current sequence, may parse a third syntax element indicating whether the LIC mode is used in the current block, and, when the third syntax element indicates whether the LIC mode is used in the current block, may predict the current block based on the LIC mode. The first syntax element may be included in at least one of a sequence parameter set (SPS) RBSP syntax and a video parameter set (VPS) RBSP syntax. The second syntax element may be included in the SPS RBSP syntax. When the value of the first syntax element is 1, the value of the second syntax element may be set to 0 that is a value indicating that the LIC mode is not used, irrespective of the result of parsing the second syntax element. When the value of the first syntax element is 0, the value of syntax element is not constrained.

In the specification, the third syntax element may indicate whether the LIC mode is used in the current block. In this instance, the processor may configure a first template including neighboring blocks of the current block, may second configure template including neighboring blocks of a reference block of the current block, may obtain an LIC linear model based on the first template and the second template, and may predict the current block based on the LIC linear model, and the location and the size of the first template correspond to the location and the size of the second template.

In the specification, when an encoding mode of the current block is a GPM mode, and the third syntax element indicates whether the LIC mode is used in the current block, the current block may be divided into a first area and a second area. In this instance, the processor may obtain a first LIC linear model for the first area, may obtain, based on the first LIC linear model, a first prediction block for the first area, may obtain a second LIC linear model for the second area, may obtain, based on the second LIC linear model, a second prediction block for the second area, and based on the first prediction block and the second prediction block, may predict the current block.

In the specification, the third syntax element may indicate whether the LIC mode is used in the current block. In this instance, the processor may configure a template including neighboring blocks located in a predetermined range from the current block, may obtain a convolutional model based on the template, and may predict the current block based on the convolutional model.

In the specification, a video signal encoding apparatus may obtain a bitstream decoded by a decoding method.

In the specification, in a computer-readable non-transitory storage medium that stores a bitstream, the bitstream is decoded by a decoding method.

In the specification, the decoding method may include an operation of parsing a first syntax element that is a general constraint information (GCI) syntax element from a bitstream, an operation parsing a second syntax element indicating whether an LIC mode is available for a current sequence, an operation of parsing, based on a result of parsing the second syntax element, a third syntax element indicating whether the LIC mode is used in the current block, an operation of predicting the current block based on the LIC mode when the third syntax element indicates whether the LIC mode is used in the current block. The first syntax element may be included in at least one of a sequence parameter set (SPS) RBSP syntax and a video parameter set (VPS) RBSP syntax. The second syntax element may be included in the SPS RBSP syntax. When a value of the first syntax element is 1, a value of the second syntax element may be set to 0 that is a value indicating that the LIC mode is not used, irrespective of a result of parsing the second syntax element. When the value of the first syntax element is 0, the value of the second syntax element may not be constrained.

In the specification, the third syntax element may indicate whether the LIC mode is used in the current block. In this instance, the decoding method may include an template including operation of configuring a first neighboring blocks of the current block, an operation of configuring a second template including neighboring blocks of a reference block of the current block, an operation of obtaining an LIC linear model based on the first template and the second template, and an operation of predicting the current block based on the LIC linear model, and a location and a size of the first template may correspond to a location and a size of the second template.

In the specification, when the encoding mode of the current block is a GPM mode, and the third syntax element indicates whether the LIC mode is used in the current block, the current block may be divided into a first area and a second area. In this instance, the decoding method may include an operation of obtaining a first LIC linear model for the first area, an operation of obtaining a first prediction block for the first area based on the first LIC linear model, an operation of obtaining a second LIC linear model for the second area, an operation of obtaining a second prediction block for the second area based on the second LIC linear model, and an operation of predicting the current block based on the first prediction block and the second prediction block.

In the specification, the third syntax element may indicate whether the LIC mode is used in the current block. In this instance, the decoding method may include an operation of configuring a template including neighboring blocks located in a predetermined range from the current block, an operation of obtaining a convolutional model based on the template, and an operation of predicting the current block based on the convolutional model.

In the specification, the third syntax element may be parsed when the second syntax element indicates that the LIC mode is available for the current block.

In the specification, the third syntax element may be parsed by additionally taking into consideration at least one of the number of samples of the current block, an encoding mode of the current block, and a prediction direction associated with the current block.

In the specification, the third syntax element may be parsed when the number of samples of the current block is 32 or more.

In the specification, the third syntax element may be parsed when the encoding mode of the current block is not a merge mode, an IBC mode, and a CIIP mode.

In the specification, the third syntax element may be parsed when the prediction direction associated with the coding block is not bi-prediction.

In the specification, the first template may include upper side neighboring blocks of the current block, and the second template may include upper side neighboring blocks of the reference block.

In the specification, the first template may include left side neighboring blocks of the current block, and the second template may include left side neighboring blocks of the reference block.

In the specification, the first template may include upper side neighboring blocks of the current block and left side neighboring blocks of the current block, and the second template may include upper side neighboring blocks of the reference block and left side neighboring blocks of the reference block.

In the specification, the current block may be one sample. A filter coefficient of the convolutional model may be a coefficient of at least one sample among an upper side sample, a lower side sample, a left side sample, and a right side sample of the one sample.

In the specification, when one or more samples among the upper side sample, the lower side sample, the left side sample, and the right side sample of the one sample are not included in the template, the value of the sample that is not included in the template may be the mean value of the samples remaining after excluding the sample that is not included in the template.

In the specification, when one or more samples among the upper side sample, the lower side sample, the left side sample, and the right side sample of the one sample are not included in the template, the value of the sample that is not included in the template may be identical to a value of a sample closest to the sample that is not included in the template, among the samples included in the template.

### Advantageous Effects of Invention

The present disclosure provides a method for efficiently processing a video signal.

The effects obtainable from the present specification are not limited to the effects mentioned above, and other effects not mentioned may be clearly understood by to those skilled in the art, to which the present disclosure belongs, from the description below.

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction.

FIG. 8 is a diagram illustrating a process of operating local illumination compensation (LIC) according to an embodiment of the disclosure.

FIG. 9 is a diagram illustrating a method in which LIC is applied in units of sub-blocks according to an embodiment of the disclosure.

FIGS. 10-1, 10-2, and 10-3 are diagrams illustrating a method in which LIC is applied in units of components of a current coding block according to an embodiment of the disclosure.

FIGS. 11-1 to 11-7 are diagrams illustrating the structure of a high-level syntax according to an embodiment of the disclosure.

FIGS. 12-1 to 12-4 are diagrams illustrating a method of signaling LIC related information according to an embodiment of the disclosure.

FIG. 13 is a diagram illustrating a method of signaling an LIC-related syntax element in coding units according to an embodiment of the disclosure.

FIGS. 14-1 to 14-4 are diagrams illustrating a geometry partitioning mode (GPM) mode according to an embodiment of the disclosure.

FIGS. 15-1 and 15-2 diagrams illustrating a method of dividing a current coding unit for a GPM mode and configuring a merge list according to an embodiment of the disclosure.

FIGS. 16-1 to 16-3 are diagrams illustrating a method in which LIC is applied in a GPM mode according to an embodiment of the disclosure.

FIG. 17 is a diagram illustrating a syntax structure including a syntax element indicating whether LIC is applied for a GPM mode according to an embodiment of the disclosure.

FIG. 18 is a diagram illustrating a method in which LIC is applied when bi-inter-prediction is applied for predicting a current block according to an embodiment of the disclosure.

FIG. 19 is a diagram illustrating a configuration of a template for applying an LIC linear model according to an embodiment of the disclosure.

FIGS. 20-1 and 20-2 are diagrams illustrating a context model of a syntax element related to a template configuration for an LIC linear model according to an embodiment of the disclosure.

FIGS. 21-a to 21-c are diagrams illustrating a method of applying an LIC linear model in the form of convolutional model according to an embodiment of the disclosure.

FIGS. 22-a and 22-b are diagrams illustrating templates for a filter coefficient of a convolutional model according to an embodiment of the disclosure.

FIG. 23 is a diagram illustrating a method of applying a filter coefficient of a convolutional model and a padding method.

FIGS. 24-a to 24-d are diagrams illustrating the forms of a filter of a convolutional model according to an embodiment of the disclosure.

FIGS. 25-a and 25-b are diagrams illustrating a method of updating an LIC linear model.

FIG. 26 is a flowchart illustrating a method of predicting a current block according to an embodiment of the disclosure.

### BEST MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

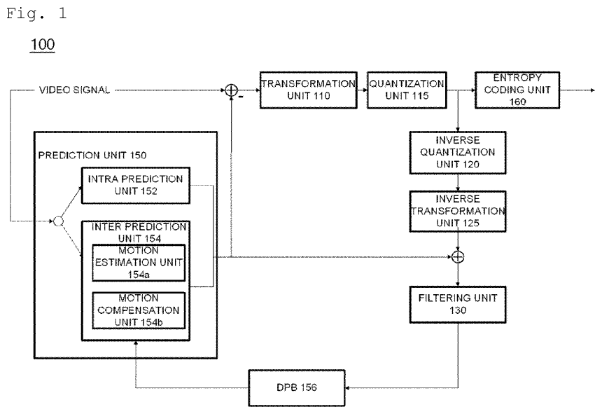

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the: transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending the strength of deblocking filtering.

Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval: is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

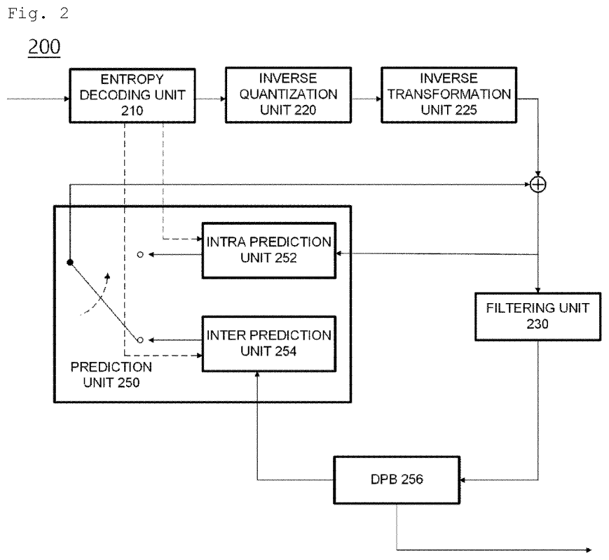

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 restores a residual value by using the inverse-quantized transform coefficient. The video signal processing device 200 restores an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the encoding intra information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the above right (AR) block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and value the residual outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

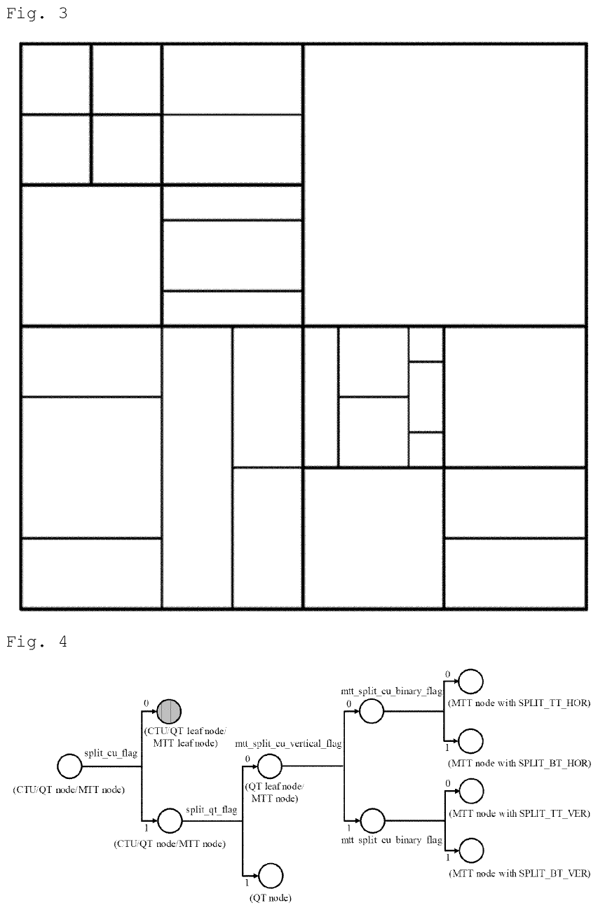

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not unit may have a square or be constant. The coding rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

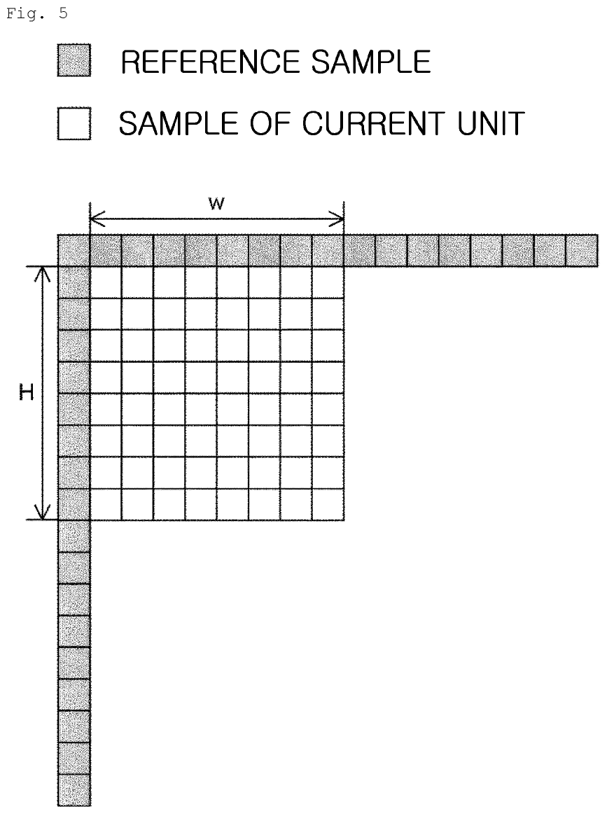

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’ indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

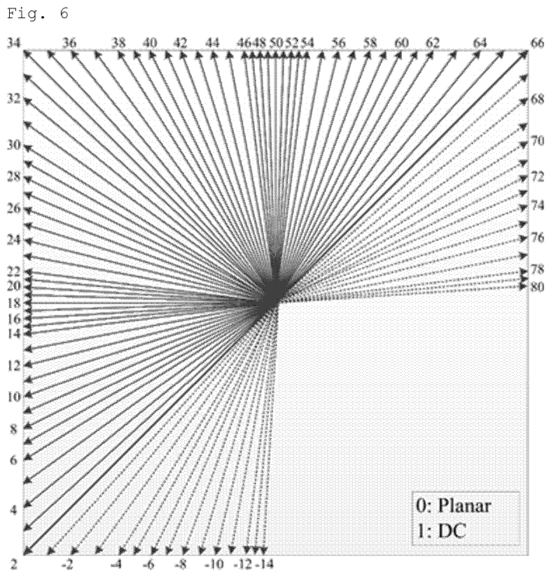

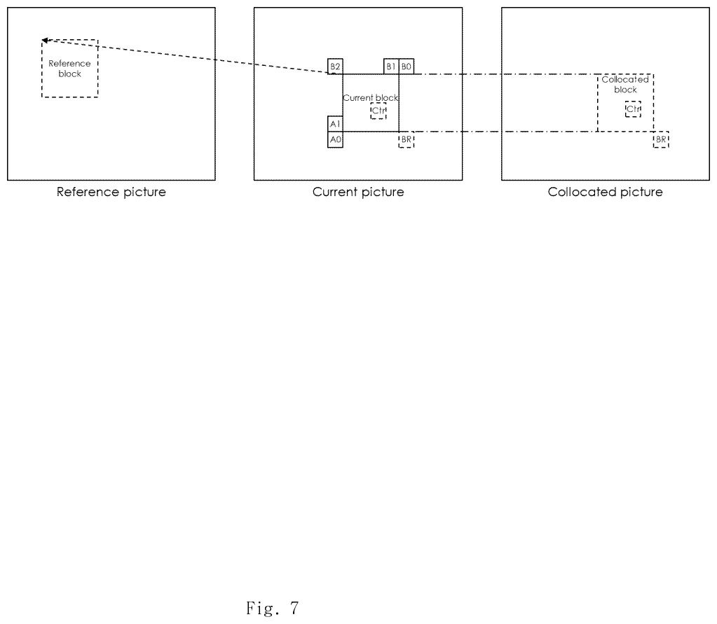

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is WXH and samples of a single reference line adjacent to the current block are used for intra prediction, reference samples may be configured using a maximum of 2 W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been restored, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than-135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2, 3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP (advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already restored reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters.

In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (B0) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in present the specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

A coding unit generally described the specification may imply the same meaning as a coding block. In addition, prediction of a coding unit (block) described generally in the specification may be the same meaning as restoration of a coding unit (block).

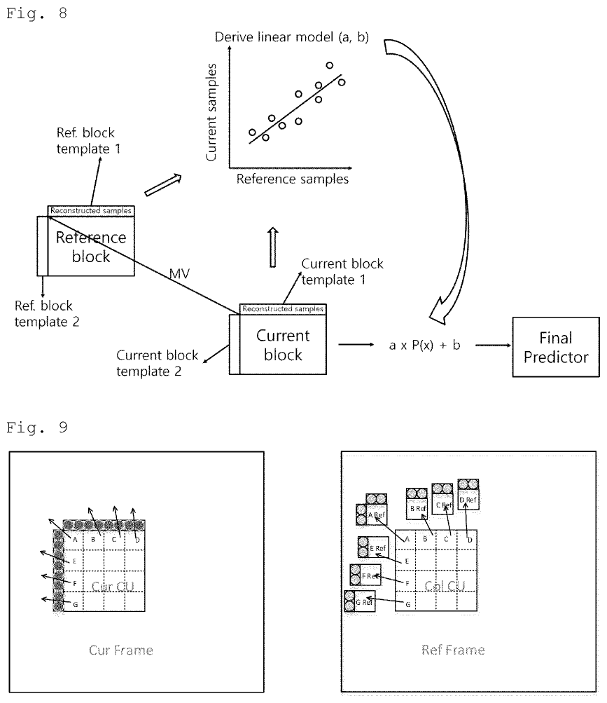

FIG. 8 is a diagram illustrating a process of operating local illumination compensation (LIC) according to an embodiment of the disclosure.

The LIC is a method of predicting a current coding block by using a linear model associated with a change in illumination (brightness) of the current coding block and a reference block. The LIC may be adaptively applied to a coding block of which prediction is performed between screens. The LIC may be applied to each of a luma component, a Cb component, and a Cr component of the current coding block. Equation 1 expresses a linear model used for LIC.

$${P}^{′} ( x ) + axP ( x ) + b \qquad [ Equation 1 ]$$

In Equation 1, each parameter may be as follows. P′ (x) denotes a sample value of a reference block, to which an LIC method is applied, P(x) denotes a sample value of the reference block, a denotes a scale coefficient, and b denotes an offset value.

In Equation 1, a and b may be obtained by using a least-squares error method. a and b may be least-squares errors of neighboring samples of the current coding block and neighboring samples of the reference block. a and b may be obtained via Equation 2.

$$a = \frac{N \sum xy - \sum x \sum y}{N \sum {x}^{2} - \sum x \sum y} , b = \sum y - a \sum x \qquad [ Equation 2 ]$$

In Equation 2, x denotes the value of a neighboring sample of the reference block, y denotes the value of a neighboring sample of the current coding block, and N denotes the number of neighboring samples. In this instance, the number of neighboring samples of the reference block and the number of neighboring samples of the current coding block are the same, and relative locations of corresponding samples may also be the same. The number of samples and the locations thereof may be variously defined. In the specification, the number of samples and the locations thereof may be described via an LIC template. Referring to FIG. 8, a decoder may obtain a linear model by using a template of the current coding block (current block template 1, 2) (y of Equation 2) and a template of the reference block based on a motion vector (MV) of the current coding block (Ref. block template 1, 2) (x of Equation 2), and may predict the current coding block. Sample values of the reference block obtained via the LIC method (via Equation 1) may be a final predictor for inter-prediction.

In the case in which the current coding block is encoded according to a merge mode, the LIC method may be applied in order to predict the current coding block. A predetermined flag (syntax element) which indicates whether the LIC method is applied may be signaled in units of coding blocks. In addition, a flag (syntax element) indicating whether to enable the LIC method in an SPS level or a slice level may be signaled. An encoder may produce a bit stream including a predetermined flag (syntax element) indicating whether the LIC method is applied in units of coding blocks, and a flag (syntax element) indicating whether to enable the LIC method in an SPS level or a slice level.

The cases in which the LIC method is not applied to a coding block may be as follows. The cases may include i) the case in which the number of the entire samples of a coding block is less than 32, ii) the case in which an block is a geometric encoding mode of a coding partitioning merge (GPM) mode, iii) the case in which an encoding mode of a coding block is an intra block copy (IBC) mode, iv) the case in which an encoding mode of a coding block is a combined intra and inter prediction (CIIP) mode, and v) the case in which an inter bi-prediction is applied to a coding block. When at least one of the cases is satisfied, the current coding block may not be predicted via the LIC method.

FIG. 9 is a diagram illustrating a method in which LIC is applied in units of sub-blocks according to an embodiment of the disclosure.

A current coding block may be divided into a plurality of sub-blocks. A decoder may perform inter-prediction in units of sub-blocks, and may restore the current coding block. In the case of inter-prediction, a neighboring block for an LIC method may be a neighboring block based on motion information of each sub-block. A neighboring block based on motion information of each sub-block may be a block on the left of a top-left sub-block and a block in the upper side of the top-left sub-block in the case of the top-left sub-block, and may be a neighboring block may be a block on the left of each of the remaining sub-blocks and a block in the upper side of each of the remaining sub-blocks in the case of the remaining sub-blocks. For example, with reference to FIG. 9, a neighboring block based on motion information of each sub-block may be a block on the left of sub-block A and a block in the upper side of sub-block A in the case of sub-block A of the current coding block, may be blocks in the upper side in the case of the sub-blocks B, C, and D, and may be blocks on the left of sub-blocks E, F, and G.

FIGS. 10-1, 10-2, and 10-3 are diagrams illustrating a method in which LIC is applied in units of components of a current coding block according to an embodiment of the disclosure.

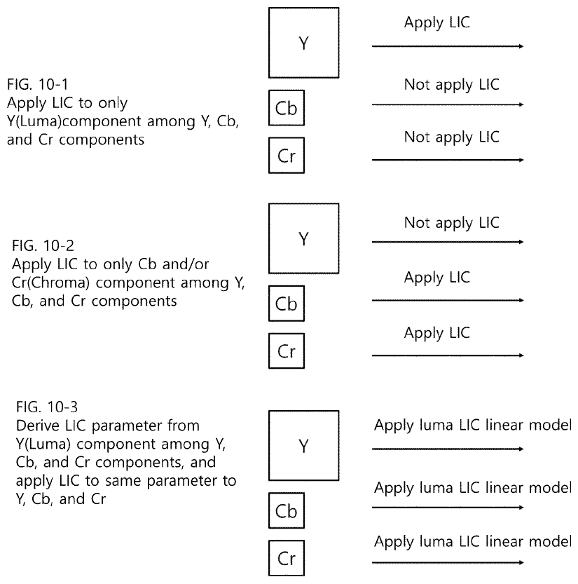

The current coding block may be configured with blocks of a luma component and a chroma component. For example, the current coding block may be configured with one configuration among Y, Cb, and Cr component blocks, R, G, and B component blocks, and Y, Cg, and Co component blocks. In this instance, an LIC method based on a linear model may be applied to each of the constituent components. The LIC method based on a linear model may be applied to all the constituent components or the LIC method based on a linear model may be applied to some of the constituent components. A decoder may receive syntax element (flag) indicating a signaling of a component block to which the LIC method is applied, for each coding block. In the case in which the current coding block is configured with Y, Cb, and Cr components blocks, with reference to FIG. 10-1, the LIC method may be applied to only a luma component block (a Y component block) and may not be applied to chrominance component blocks (a Cb component block and a Cr component block). In the case in which the current coding block is configured with Y, Cb, and Cr component blocks, with reference to FIG. 10-2, the LIC method may not be applied to a luma component block (a Y component block) and may be applied to chrominance component blocks (a Cb component block and a Cr component block). In the case in which the current coding block is configured with Y, Cb, and Cr component blocks, with reference to FIG. 10-3, the LIC method may be applied to a luma component block (a Y component block) and chrominance component blocks (a Cb component block and a Cr component block). Although not illustrated, the LIC method may be applied to a luma component block (a Y block) and some of the chrominance component blocks (a Cb block or a Cr block). Alternatively, the LIC method may be applied only to some of the chrominance component blocks (a Cb block or a Cr block).

FIGS. 11-1 to 11-7 are diagrams illustrating the structure of a high-level syntax according to an embodiment of the disclosure.

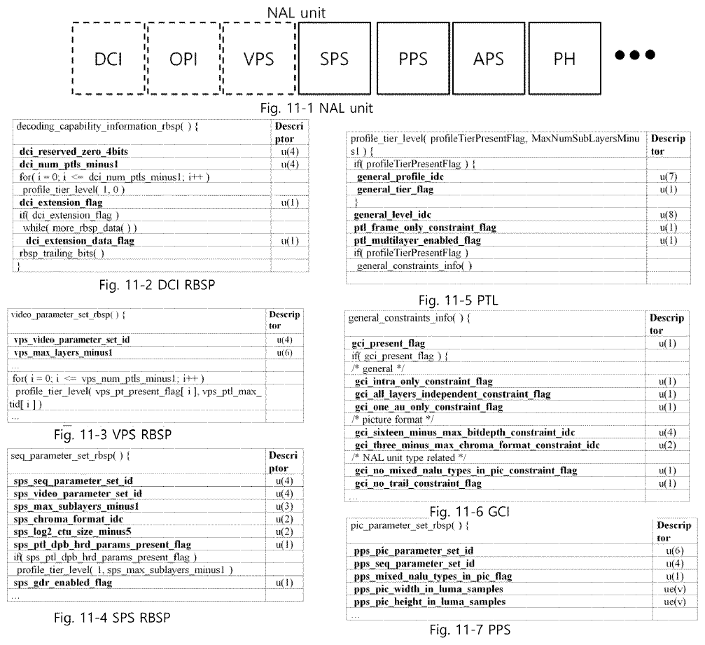

A bitstream may be capsulated by using a network abstraction layer (NAL) unit as a basic unit. That is, a bitstream may be configured with one or more network abstraction layer (NAL) units. Referring to FIG. 11-1, a NAL unit may be configured in an order of a decoding capability information (DCI) raw byte sequence payload (RBSP), an operation point information (OPI) RBSP, a video parameter set (VPS) RBSP, a sequence parameter set (SPS) RBSP, a picture parameter set (PPS) RBSP, an adaption parameter set (APS) RBSP, and a picture header (PH). In this instance, the DCI RBSP, the OPI RBSP, and the VPS RBSP may be selectively signaled.

FIG. 11-2 illustrates the structure of a DCI RBSP, FIG. 11-3 illustrates the structure of a VPS RBSP, and FIG. 11-4 illustrates the structure of an SPS RBSP. FIG. 11-5 illustrates the structure of a PTL (profile tier level) configured with profile information, tier information, and level information of a video sequence. FIG. 11-6 illustrates the structure of general constraints information (GCI). A syntax element (GCI syntax element) included in the GCI may perform control so as to disable a tool and/or a function or the like included in the GCI and/or other syntax structures (e.g., a VPS RBSP syntax structure, an SPS RBSP syntax structure, a PPS RBSP syntax structure, or the like) for interoperability. In the case in which a syntax included in the GCI indicates disabling a tool and/or a function or the like, tools and/or functions declared in a lower syntax may be disabled. In this instance, depending on the location of an NAL unit that the decoder parses, whether a tool and/or a function or the like disabled by the GCI syntax is to be applied to the entire bitstream or a partial bit stream may be determined. The PTL may be included in the DCI RBSP, the VPS RBSP, and the SPS RBSP, and may be signaled. The GCI may be included in the PTL and signaled.

FIGS. 12-1 to 12-4 are diagrams illustrating a method of signaling LIC related information according to an embodiment of the disclosure.

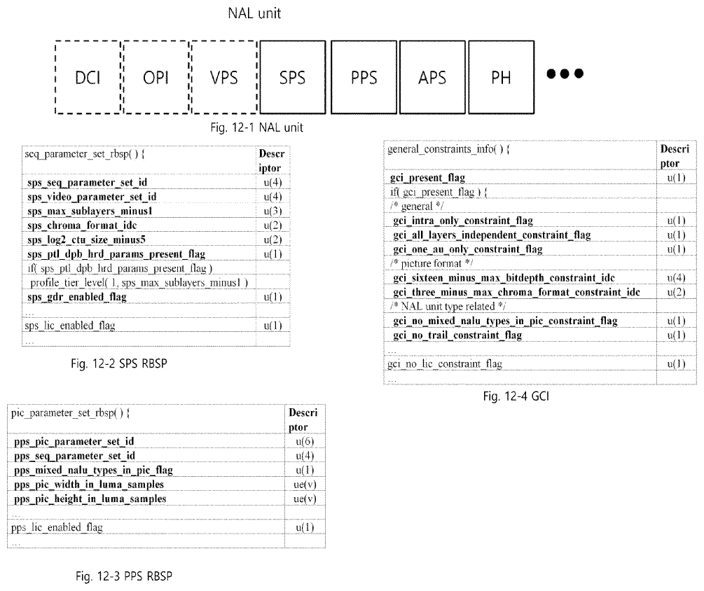

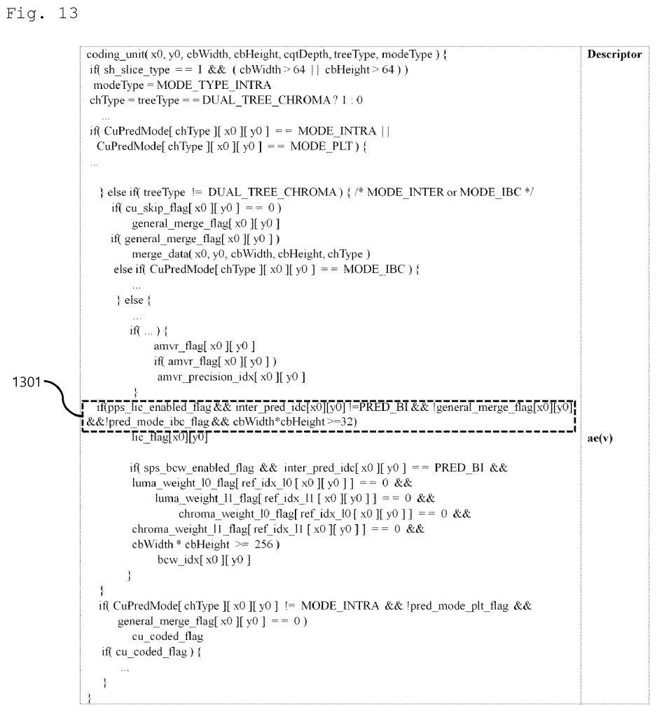

Information related to LIC may be included in an SPS RBSP, a PPS RBSP, and GCI. Referring to FIG. 12-2, the SPS RBSP may include a syntax element (sps_lic_enabled_flag) indicating whether to enable LIC in a sequence level. In the case in which the value of sps_lic_enaled_flag is 1, this indicates that LIC is enabled with respect to a picture that refers to an SPS. In the case in which the value of sps_lic_enaled_flag is 0, this indicates that LIC is disabled with respect to a picture that refers to an SPS. In addition, irrespective of controlling whether to enable the LIC in a sequence level, whether to enable the LIC may be controlled in a picture (or frame) level. Referring to FIG. 12-3, the PPS RBSP may include a syntax element (pps_lic_enabled_flag) indicating whether to enable LIC in a picture (frame) level. In the case in which the value of pps_lic_enabled_flag is 1, this may indicate that the LIC is enabled with respect to a picture that refers to a PPS. In the case in which the value of pps_lic_enabled_flag is 0, this may indicate that the LIC is disabled with respect to a picture that refers to a PPS (pps_lic_enabled_flag equal to 1 specifies that the LIC is enabled for pictures referring to the PPS. pps_lic_enabled_flag equal to 0 specifies that the LIC is disabled for pictures referring to the PPS). Referring to FIG. 12-4, the GCI may include a syntax element (gci_no_lic_constraint_flag) indicating whether to enable LIC in an SPS level. In the case in which the value of gci_no_lic_constraint_flag is 1, this indicates that the value of sps_lic_enabled_flag for all pictures of OlsInScope is 0. In the case in which the value of gci_no_lic_constraint_flag is 0, this indicates that the value of sps_lic_enabled_flag is not constrained (gci_no_lic_constraint_flag equal to 1 specifies that sps_lic_enabled_flag for all pictures in OlsInScope shall be equal to 0. gci_no_lic_constraint_flag equal to 0 does not impose such a constraint). gci_no_lic_constraint_flag may be a syntax element that performs a function of imposing a constraint on sps_lic_enabled_flag.

FIG. 13 is a diagram illustrating a method of signaling an LIC-related syntax element in coding units according to an embodiment of the disclosure.

A syntax element (lic_flag) indicating whether LIC is applied to a current coding unit (block) may be signaled based on a coding unit. lic_flag may be signaled based on the value of pps_lic_enabled_flag. For example, in the case in which the value of pps_lic_enabled_flag is 1 (i.e., true), lic_flag may be signaled. In the case in which the value of lic_flag is 1, this indicates that an LIC method is applied to the current coding unit. In the case in which the value of lic_flag is 0, this indicates that the LIC method is not applied to the current coding unit. In the case in which an encoding mode of the current coding unit is a merge mode, a decoder may obtain information associated with whether the LIC method is applied, via a reference block that is adjacent to the current coding unit. Accordingly, in the case in which the encoding mode of the current coding unit is a merge mode, lic_flag may not be signaled. Specifically, with reference to 1301 of FIG. 13, a condition for signaling of lic_flag according to an embodiment of the disclosure may be as follows. lic_flag may be signaled i) when the value of pps_lic_enabled_flag is 1 (i.e., true), ii) when the inter-prediction with respect to the current coding unit is not bi-prediction, iii) when an encoding mode of the current coding unit is not a merge mode, iv) when an encoding mode of the current coding unit is not an IBC mode, and v) when the number of samples of the current coding unit is greater than or equal to 32. In this instance, in condition v), the number of samples of the current coding unit may be expressed by a product of the width and the height of the current coding unit.

FIGS. 14-1 to 14-4 are diagrams illustrating a geometry partitioning mode (GPM) mode according to an embodiment of the disclosure.

A GPM mode is a mode in which a current coding unit is divided into two areas based on a single straight boundary line, and intra-prediction is performed with respect to each of the two division areas, so that a prediction signal of the current coding unit is obtained. That is, a decoder may perform intra-prediction by using different pieces of motion information for two division areas, respectively, so as to produce a prediction signal (P0, P1) for each of the two division areas. The decoder may mix P0 and P1 so as to obtain a prediction signal of the current coding unit. Specifically, P0 and P1 may be produced by using a mixed matrix (w0, w1). In this instance, the mixed matrix may have a value in the range of 0 to 8.

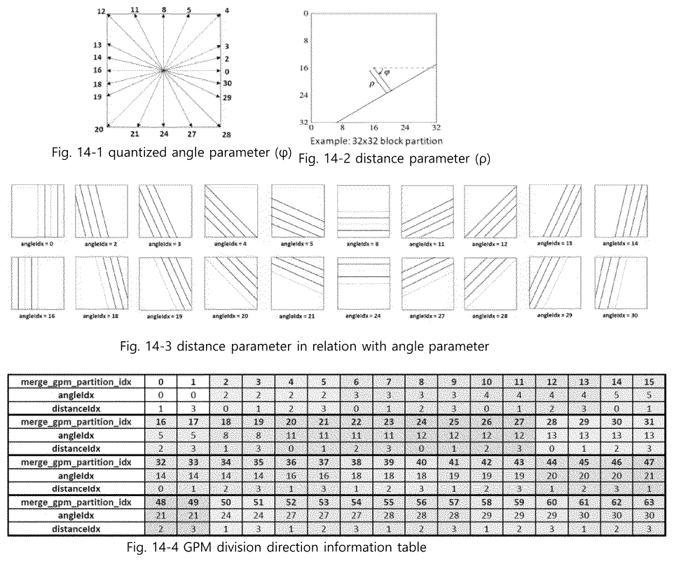

Referring to FIG. 14-1, a quantized angle parameter (p) may be a total of 20 quantized angles which are produced via symmetrical division of a range of [0, 2π]. With reference to FIG. 14-2 and FIG. 14-3, a distance parameter (p) may be defined as 4 quantized distances. FIG. 14-3 illustrates 4 distance parameters for each quantized angle parameter. Referring to FIG. 14-4, a separate table for a GPM mode may be defined. In this instance, the table shows division direction information and defines a combination of an angle parameter (angleIdx) and a distance parameter (distanceIdx). The table may include a total of 64 pieces of division direction information excluding division direction information that is a duplicate of a binary tree split and a ternary tree split among a total of 70 combinable division directions (excluding 10 duplicate divisions). The Angle parameter (angleIdx) may be a total of 20 quantized angles (φ) produced via symmetrical division of FIG. 14-1, and the distance parameter (distanceIdx) may be a distance parameter (ρ) of FIG. 14-2. Each combination of an angle parameter (angleIdx) and a distance parameter (distanceIdx) may be indexed. A decoder may identify an index for each combination of an angle parameter (angleIdx) and a distance parameter (distanceIdx) via a syntax element (merge_gpm_partition_idx[x0] [y0]), and may obtain division direction information.

FIGS. 15-1 and 15-2 are diagrams illustrating a method of dividing a current coding unit for a GPM mode and configuring a merge list according to an embodiment of the disclosure.

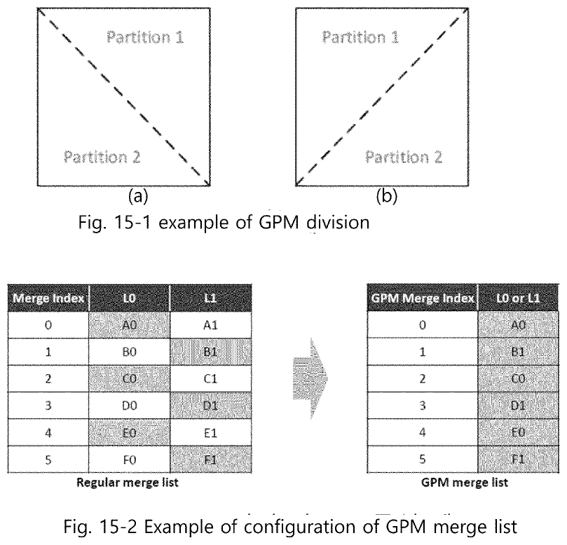

FIG. 15-1 (a) illustrates division of a current coding unit when the value of merge_gpm_partition_idx[x0] [y0] is 24. Referring to FIG. 14-4, in the case in which the value of merge_gpm_partition_idx [x0] [y0] is 24, angleIdx may be 12 and distanceIdx may be 0. FIG. 15-1 (b) illustrates division of a current coding unit when the value of merge_gpm_partition_idx [x0] [y0] is 10. Referring to FIG. 14-4, in the case in which the value of merge_gpm_partition_idx [x0] [y0] is 10, angleIdx may be 4 and distanceIdx may be 0. FIG. 15-2 illustrates a merge list in a GPM mode. Referring to FIG. 15-2, a merge list in a GPM mode (GPM merge list) may be configured with only unit-directional motion information of a regular merge candidate list (regular merge list). A candidate indexed by an even number in the merge list in the GPM mode is motion information of list L0, and a candidate indexed by an odd number may be motion information of list L1.

FIGS. 16-1 to 16-3 are diagrams illustrating a method in which LIC is applied in a GPM mode according to an embodiment of the disclosure.

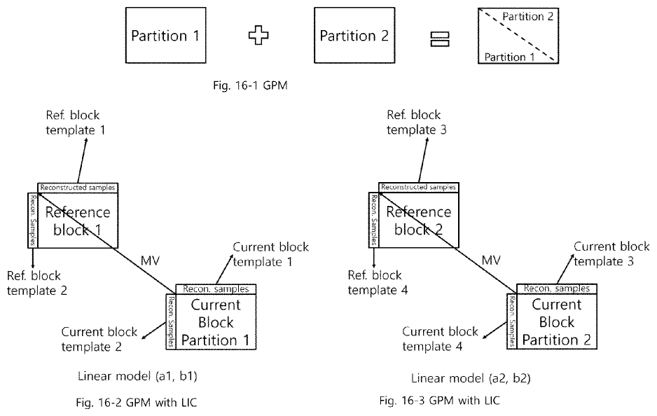

Referring to FIG. 16-1, in the case in which a GPM mode is used for predicting a current coding unit, the current coding unit may be divided into two areas (partition 1, partition 2) via a single straight boundary line. A decoder may derive a linear model for each of partition 1 and partition 2 and may apply an LIC method. Specifically, referring to FIGS. 16-2 and 16-3, the decoder may obtain a1 and b1 by deriving a linear model for partition 1, and may apply the LIC method. The decoder may obtain a2 and ab by deriving a linear model for partition 2, and may apply the LIC method. That is, the decoder may derive a1 and b1 by using an LIC template for a reference block (reference block 1) based on an MV of the current coding block and an LIC template for partition 1. In the same manner, the decoder may derive a2 and b2 by using an LIC template for a reference block (reference block 2) based on an MV of the current coding block and an LIC template for partition 2. In this instance, reference block 1 and reference block 2 may be different blocks, and an MV corresponding to reference block 1 and an MV corresponding to reference block 2 may be different from each other. The LIC template for the current coding unit may be divided, by a single straight boundary line, into the LIC template for partition 1 and the LIC template for partition 2 In the same manner, the LIC template for a reference block may be divided into two templates by a single straight boundary line, and LIC templates for the two division reference blocks may correspond to an LIC template for partition 1 and an LIC template for partition 2, respectively. a1, b1, a2, and b2 may be parameters for a linear model. a1 and b1 may be values corresponding to a and b of Equation 1 and Equation 2, and a2 and b2 may also be values corresponding to a and b of Equation 1 and Equation 2. The decoder may obtain a prediction signal for partition 1 via the LIC method by using a1 and b1. The decoder may obtain a prediction signal for partition 2 via the LIC method by using a2 and b2. Subsequently, the decoder may obtain a prediction signal of the current coding unit by mixing the prediction signal for partition 1 and the prediction signal for partition 2 according to the above-described method. In addition, the decoder may derive a linear model parameter for one of partition 1 and partition 2, and may apply the same parameter to the remaining area.

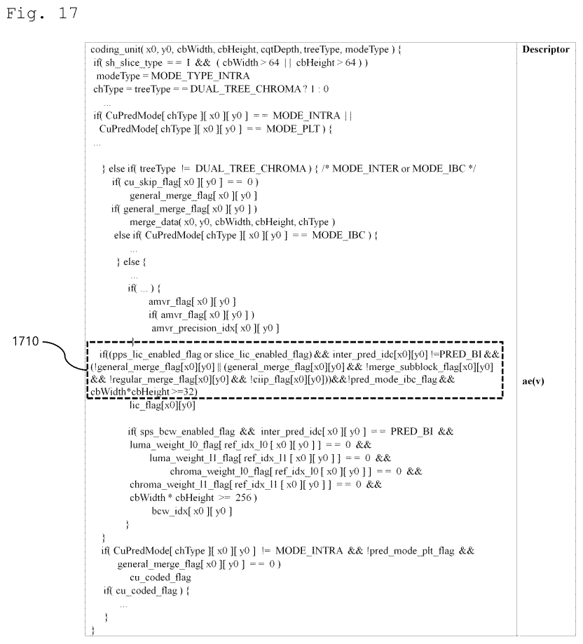

FIG. 17 is a diagram illustrating a syntax structure including a syntax element indicating whether LIC is applied for a GPM mode according to an embodiment of the disclosure.

A condition for signaling of lic_flag in the case in which a GPM mode is applied to a current coding unit will be described. That is, in the case in which the GPM mode is applied to the current coding unit, the decoder may parse lic_flag based on the condition listed in Table 1 (the diagram 1710 of FIG. 17).

TABLE 1
pps_lic_enabled_flag or slice_lic_enabled_flag && inter_pred_idc[x0][y0] != PRED_BI &&
(!general_merge_flag[x0][y0] ∥ (general_merge_flag[x0][y0] && !merge_subblock_flag[x0][y0]
&& !regular_merge_flag[x0][y0] && !ciip_flag[x0][y0])) && !pred_mode_ibc_flag &&
cbWidth*cbHeight > =32

Specifically, referring to Table 1 and diagram 1710 of FIG. 17, lic_flag according to an embodiment of the disclosure may be parsed i) when the value of pps_lic_enabled_flag or slice_lic_enabled_flag is 1 (i.e., true), ii) when inter-prediction for the current coding unit is not bi-prediction, iii) when an encoding mode of the current coding unit is not a merge mode, or when an encoding mode of the current coding unit is a merge mode and the merge mode is not a merge mode in units of sub-blocks but a merge mode in coding units, and the merge mode is not a regular merge mode nor mmvd merge mode, and a CIIP mode for restoring the current coding unit is not used, iv) when an encoding mode of the current coding unit is not an IBC mode, and v) when the number of samples of the current coding unit is greater than or equal to 32. In this instance, the number of samples of the current coding unit in condition v) may be expressed by the product of the width and the height of the current coding unit, and a value with which the number of samples is compared is a predetermined value and may be a value different from 32.

In the case in which inter-prediction is applied in order to predict the current coding unit, a condition for using the GPM mode is as shown in Table 2.

TABLE 2
general_merge_flag[x0][y0]==1 && merge_subblock_flag[x0][y0]==0 &&
regular_merge_flag[x0][y0]==0 && ciip_flag[x0][y0]==0

With reference to Table 2, when the encoding mode of the current coding unit is a merge mode (general_merge_flag[x0] [y0]==1) and the merge mode is not a merge in mode units of sub-blocks (merge_subblock_flag[x0] [y0]==0) but a merge mode in coding units, and the merge mode is not a regular merge mode nor mmvd merge mode (regular_merge_flag[x0] [y0]==0), and a CIIP mode is not used for predicting the current coding unit (ciip_flag[x0] [y0]==0), the GPM mode may be used. That is, when the condition of Table 2 is satisfied, the current coding unit may be predicted according to the GPM mode.

Hereinafter, embodiments in which lic_flag is signaled when the GPM mode is used will be described.

According to the GPM mode, the current coding unit may be divided into two areas (partitions). In this instance, lic_flag may be signaled for each area. In this instance, lic_flag may be separated as gpm0_lic_flag and gpm1_lic_flag and may be signaled to corresponding areas, respectively. That is, the decoder may parse gpm0_lic_flag indicating whether the LIC mode is applied to a first area and parge gpm1_lic_flag indicating whether the LIC mode is applied to a second area, respectively, and may determine whether an LIC is applied to each area.

In addition, based on whether LIC is applied to a neighboring block of the current coding unit, whether LIC is applied to each of one or more of the two areas.

In addition, based on whether LIC is applied to a neighboring block, the decoder may determine whether LIC is applied to the first area. The decoder may determine that LIC is not applied to the second area, irrespective of whether LIC is applied to a neighboring block. The first area may be highly associated with an adjacent neighboring block. However, in the case of the second area, it is difficult to configure a template adjacent to the second area. This may be the case in which the current coding unit is divided into a first area, which is adjacent to an upper side neighboring block and a left side neighboring block of the current coding unit, and a second area, which is not adjacent to an upper side neighboring block and a left side neighboring block of the current coding unit.

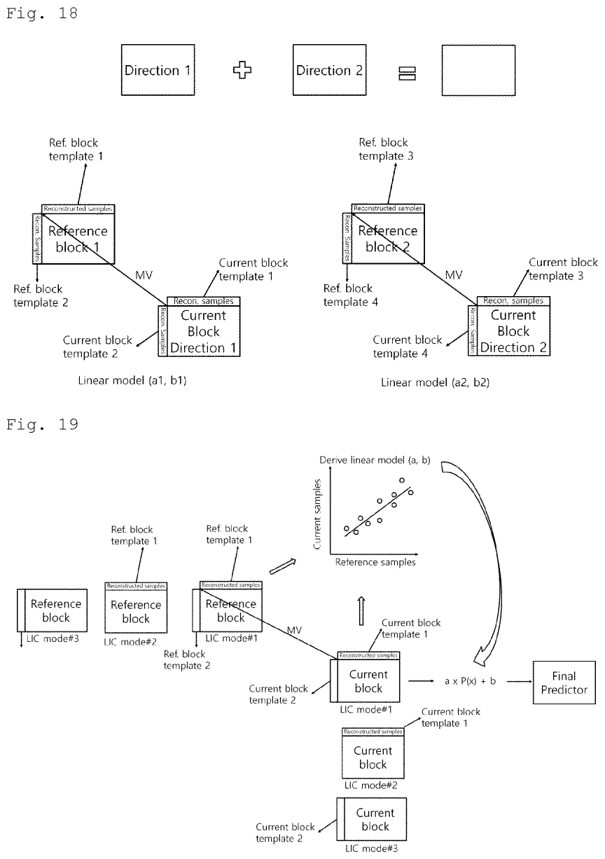

FIG. 18 is a diagram illustrating a method in which LIC is applied when bi-inter-prediction is applied for predicting a current block according to an embodiment of the disclosure.

When performing a regular bi-intra-prediction, a decoder may perform bi-intra-prediction by using a reference block of a first picture that corresponds to a first direction and is earlier than a current picture and a reference block of a second picture that corresponds to a second direction and is later in time. The decoder may derive a parameter for an LIC linear model by using a neighboring sample of the current block, a neighboring sample of the reference block of the first picture, and a neighboring sample of the reference block of the second picture. In this instance, based on whether LIC is used for the reference block of the first picture and the reference block of the second picture, whether LIC is used for predicting the current block may be determined. In this instance, whether LIC is used for the reference block of the first picture and the reference block of the second picture may be determined, respectively, and separate signaling indicating whether LIC is used for each reference block may be present. In this instance, separate signaling (lic_flag[x0] [y0]) may be included in a coding unit syntax structure (coding_unit( ){ }). In the case in which an encoding mode of the current block is an AMVP mode, and bi-intra-prediction is applied, a condition for parsing separate signaling (lic_flag[x0] [y0]) is as shown in Table 3. When the encoding mode of the current block is a merge mode and bi-intra-prediction is applied, a condition for parsing separate signaling (lic_flag[x0] [y0]) is as shown in Table 4.

```
TABLE 3
  if((pps_lic_enabled_flag or slice_lic_enabled_flag) && !general_merge_flag[x0][y0]
&&!pred_mode_ibc_flag && cbWidth*cbHeight > =32)
  lic_flag[x0][y0]
```

```
TABLE 4
  if((pps_lic_enabled_flag or slice_lic_enabled_flag) &&
(!general_merge_flag[x0][y0] ∥ (general_merge_flag[x0][y0] &&
regular_merge_flag[x0][y0]) && !pred_mode_ibc_flag && cbWidth*cbHeight > =32)
  lic_flag[x0][y0]
```

The decoder may derive an LIC linear parameter for each direction (a first direction, a second direction), may configure a prediction block for each direction, and may obtain a weighted mean thereof, thereby producing a final prediction block. The decoder may produce a first prediction block by multiplying a first weight with the reference block corresponding to the first direction, and may produce a second prediction block by multiplying a second weight with the reference block corresponding to the second direction. The decoder may produce a final prediction block (a weighted-mean prediction block) by calculating a weighted mean of the first prediction block and the second prediction block. In this instance, the first weight and the second weight may be different from each other. The decoder may derive a parameter of an LIC linear model between a template configured with a neighboring block of the weighted-mean prediction block and a template configured with a neighboring block of the current block. The decoder may predict the current block by applying the derived parameter of the LIC linear model to the final prediction block. In this instance, to configure a template of the weighted-mean prediction block, a prediction block for each direction may be produced as a block extended as big as the size of the template. Alternatively, the decoder may configure the template for the prediction block by using the pixels in one line arranged in the top of the weighted-mean prediction block and the pixels in one line arranged in the very left of the weighted-mean prediction block.

FIG. 19 is a diagram illustrating a configuration of a template for applying an LIC linear model according to an embodiment of the disclosure.

In the case in which a neighboring block located in the upper side of a current block is a first template, and a neighboring block on the left of the current block is a second template, a template of a current coding unit for an LIC linear mode may be configured in three types of methods. Referring to FIG. 19, the configuration of the template of the current coding unit may include i) both the first template and the second template, may include ii) only the first template, or may include iii) only the second template. That is, the decoder may obtain an LIC linear model i) by using both the first template and the second template, ii) by using only the first template, or iii) by using only the second template. The features and/or distributions of the samples constituting the first template and the second template may be different and the parameter value of an LIC linear model for each template may be different and thus, a template may be configured in the three methods described above, in order to effectively predict the current block.

An encoder may indicate, based on a cost value, a method to be used for configuring a template and obtaining an LIC linear model, among the three methods described above. Specifically, the encoder may produce a bitstream including a syntax element (lic_mode_idx) indicating a template configuration or a template configuration to be used. The decoder may parse lic_mode_idx, and may identify a template to be used for obtaining an LIC linear mode. In this instance, lic_mode_idx may be parsed, only when the value of lic_flag[x0][y0] is 1 (i.e., true). In the case in which both the first template and the second template are used, the value of lic_mode_idx may be 2. In the case in which only the first template is used, the value of lic_mode_idx may be 1. In the case in which only the second template is used, the value of lic_mode_idx may be 0. In addition, lic_mode_idx may indicate a template configuration via a 2-bit value. For example, i) when the value of lic_mode_idx is 00, both the first template and the second template may be used, ii) when the value of lic_mode_idx is 10, only the first template may be used, and iii) when lic_mode_idx is 11, only the second template may be used. As another index mapping method, i) when the value of lic_mode_idx is 00, only the second template may be used, ii) when the value of lic_mode_idx is 10, only the first template may be used, and iii) when lic_mode_idx is 11, both the first and the second template may be used.

FIGS. 20-1 and 20-2 are diagrams illustrating a context model of a syntax element related to a template configuration for an LIC linear model according to an embodiment of the disclosure.

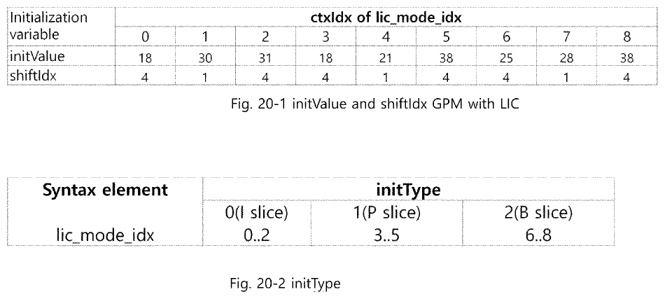

An encoder may apply a context model to a first bin, and may perform entropy coding using context adaptive binary arithmetic coding (CABAC). The context model for lic_mode_idx may be defined to be a value obtained via experiments. initValue of FIG. 20-1 indicates context models for lic_mode_idx, and shiftIdx may be used for updating a probability for lic_mode_idx. initValue and shiftIdx may be determined based on the value of ctxIdx of lic_mode_idx. initValue may be determined based on a current slice type. Specifically, initValue may be determined based on whether the current slice type is slice I, slice P, or slice B. FIG. 20-2 illustrates a context model that is available for each current slice type. Referring to FIG. 20-2, an initialization type (initType) of lic_mode_idx may be determined based on a current slice type, and initValue may be determined based on the initialization type. In the case in which the current slice type is slice I, the value of initType may be a value ranging from 0 to 2. In the case in which the current slice type is slice P, the value of initType may be a value ranging from 3 to 5. In the case in which the current slice type is slice B, the value of initType may be a value ranging from 6 to 8. The value of initType that is determined based on a slice type may be the same as the value of ctxIdx of lic_mode_idx of FIG. 20-1. initValue may be determined to be a value corresponding to FIG. 20-1 based on the value of initType determined for each current slice type. initType may be determined to be a single value for each slice type. For example, in the case in which the current slice type is slice I, the value of initType may be 0. In the case in which the current slice type is slice P, the value of initType may be 3. In the case in which the current slice type is slice B, the value of initType may be 6. initValue may be determined to be a value corresponding to FIG. 20-1 based on the value of initType determined to be a single value for each current slice type. For example, in the case in which the value of initType is 0, the value of ctxIdx of lic_mode_idx may be 0, and, according to FIG. 20-1, the value of initValue may be 18 and the value of shiftIdx may be 4.

In addition, the use of initValue depending on a slice type may be selectively applied for each slice. According to an embodiment, the order of use of the value of initValue may be changed depending on the value of lic_mode_idx defined in a slice header. In the case in which the value of lic_mode_idx is 1, and the current slice type is slice P, initValue may be 6. In the case in which the value of lic_mode_idx is 1, and the current slice type is slice B, initValue may be 3. In the case in which the value of lic_mode_idx is 0, and the current slice type is slice P, initValue may be 3. In the case in which the value of lic_mode_idx is 0, and the current slice type is slice B, initValue may be 6.

The location of a luma component block located in the top-left of the current coding unit may be expressed as (x0, y0) in the form of coordinates. A sample location (xNbL, yNbL) of a left side neighboring block of the current coding unit may be (x0-1, y0), and a sample location (xNbA, yNbA) of an upper side neighboring block of the current coding unit may be (x0, y0-1). In the case in which a sample of the upper side neighboring block is available, it may be expressed as availableA. In the case in which a sample of the left side neighboring block is available, it may be expressed as availableL. In the case in which a sample is not available, it may be expressed as FALSE.

Hereinafter, a context model associated with a symbol of lic_mode_idx that is an embodiment of the disclosure will be described.

The value of a context index (ctxInc) may be determined to be a value of between 0 and 2 when LIC is applied to both the left side neighboring block and the upper side neighboring block among the neighboring blocks of the current block. The value of ctxInc may be determined to be a value of between 0 and 1 when LIC is applied only to one of the left side neighboring block and the upper side neighboring block among the neighboring blocks of the current block. condL may indicate whether an LIC mode is applied to the left side neighboring block among the neighboring blocks of the current block. That is, based on the value of lic_mode_idx, condL may indicate whether the LIC mode is applied to the left side neighboring block. condA may indicate whether the LIC mode is applied to the upper side neighboring block among the neighboring blocks of the current block. That is, based on the value of lic_mode_idx, condA may indicate whether the LIC mode is applied to the upper side neighboring block. ctxSetIdx is a value determined based on a current slice type, and may have a value ranging from 0 to 2. Table 5 is an example of determining a context index according to an embodiment of the disclosure.

```
TABLE 5
  A. condL : lic_mode_idx[ chType ][ xNbL ][ yNbL ]
  B. condA: lic_mode_idx[ chType ][ xNbA ][ yNbA ]
  C. ctxSetIdx: 0
  D. ctxlnc (context index) = (condL && availableL) + (condA && availableA) +
ctxSetIdx*3
```

In the case in which LIC is applied to both the left side neighboring block and the upper side neighboring block of the current block, and all neighboring blocks use a template (first template) configured with blocks located in the upper side of the neighboring blocks and a template (second template) configured with blocks on the left of the neighboring blocks, the value of lic_mode_idx may be determined to be 2. In the case in which LIC is applied to both the left side neighboring block and the upper side neighboring block of the current block, and only the first template or only the second template is used for one or more among the neighboring blocks, the value of lic_mode_idx may be determined to be 1. condL may indicate whether an LIC mode is applied to the left side neighboring block among the neighboring blocks of the current block. That is, based on the value of lic_mode_idx, condL may indicate whether the LIC mode is applied to the left side neighboring block, and may be set to a value indicating a template configuration (mode). condA may indicate whether an LIC mode is applied to the upper side neighboring block among the neighboring blocks of the current block. That is, based on the value of lic_mode_idx, condA may indicate whether the LIC mode is applied to the upper side neighboring block, and may be set to a value indicating a template configuration (mode). ctxSetIdx is a value determined based on a current slice type, and may have a value ranging from 0 to 2. As described above, the template configuration (mode) may be i) the case in which both the first template and the second template are used, ii) the case in which only the first template is used, and iii) the case in which only the second template is used. In this instance, each of the template configurations of i) to iii) may be mapped to one of a first mode, a second mode, and a third mode. In addition, each mode may be indicated by a value of 0, 1, or 2 or may be indicated by a 2-bit value. Table 6 is an example of determining a context index according to an embodiment of the disclosure.

```
TABLE 6
  A. condL : lic_mode_idx[ chType ][ xNbL ][ yNbL ]== first mode indication value
  B. condA: lic_mode_ idx[ chType ][ xNbA ][ yNbA ]== first mode indication value
  C. ctxSetIdx: 0
  D. ctxlnc (context index) = (condL && availableL) + (condA && availableA) +
ctxSetIdx*3
```

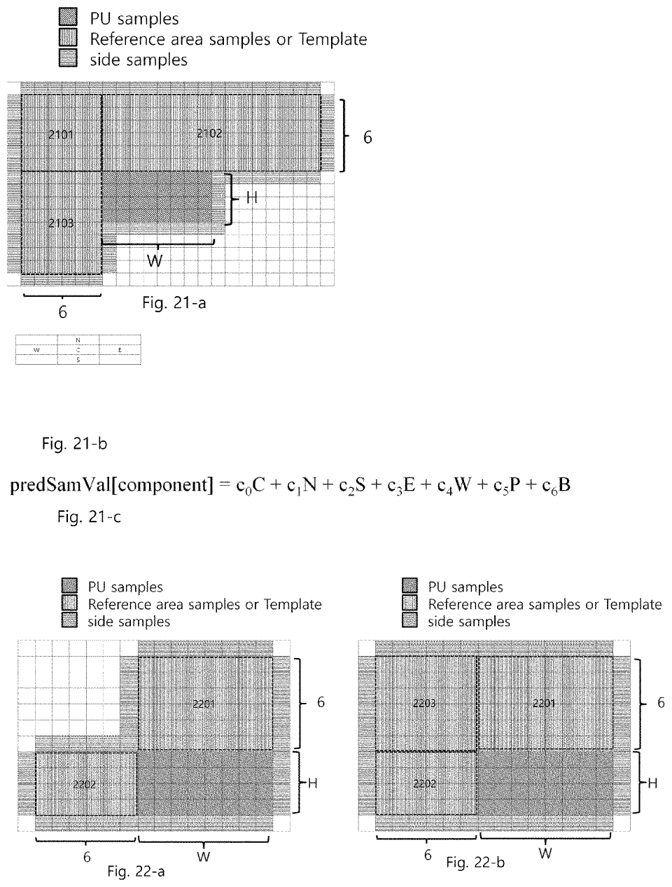

FIGS. 21-a to 21-c are diagrams illustrating a method of applying an LIC linear model in the form of a convolutional model according to an embodiment of the disclosure.

Similar to an LIC linear model, a convolutional model may derive a linear relation between a template of a current coding/prediction block and a template of a reference block, and may predict the current coding/prediction block by applying the derived linear relation to a sample of the reference block. The convolutional model may be provided in a form that includes a plurality of convolutional filter coefficients, unlike the form of Equation 1. In this instance, the number of the convolutional filter coefficients may be a predetermined number, or may be variable. A convolutional filter coefficient may be a value that minimizes a mean square error (MSE) between template samples of the current coding/prediction block and template samples of a reference block determined based on motion information. The convolutional filter coefficient may be obtained by using Cholesky decomposition or LDL decomposition. For example, in a matrix operation of Ax=B, calculation may be performed in the form of x=B/A. In this instance, a method of decomposing matrix A for easy calculation of 1/A may be Cholesky decomposition or LDL decomposition. Cholesky decomposition may be decomposed in the form of the product of a lower triangular matrix (or an upper triangular matrix) and the transposed matrix thereof, and LDL decomposition may be decomposed in the form of the product of a lower triangular matrix (or an upper triangular matrix), a diagonal matrix, and the transposed matrix of the lower triangular matrix. A lower triangular matrix may be a matrix in which components are present below a diagonal matrix of a matrix, and components of 0 are present above the diagonal matrix. The upper triangular matrix, on the contrary, may be a matrix in which components are present above a diagonal matrix and components of 0 are present below the diagonal matrix. In the matrix operation of Ax=B, A may be template values of a luma component (or a Cb component or Cr component) block of a reference block, and B may be template values of a luma component (or a Cb component or Cr component) block of the current coding/prediction block. Alternatively, A may be template values of a luma component (or a Cb component or Cr component) block of the current coding/prediction block, and B may be template values of a luma component (or a Cb component or Cr component) block of the reference block. A method of obtaining a filter coefficient may be as follows. An autocorrelation matrix may be obtained for A values, and a cross-correlation vector between A values and B values may be calculated. The autocorrelation matrix may be decomposed using LDL decomposition. The result of decomposition may be expressed as U′*D*U*x=B. U denotes an upper triangular matrix, D denotes a diagonal matrix, and U′ denotes the transposed matrix of U. A convolutional filter coefficient may be obtained by applying back substitution of Gauss-Jordan elimination to U′*D*U*x=B.

FIG. 21-a illustrates a current block, reference area samples corresponding to a template of the current block, and side samples. The side samples may be samples that are excluded from the template. The size of the template may be defined variously. For example, in the case in which the size of the current coding/prediction block is weight (W)×height (H), the size of the template may be 2 W×n+2H×n+n×n. In this instance, n is a predetermined value and may be an integer number greater than or equal to 1. Referring to FIG. 21-a, the current block may be a block having a width W and a height H, and n may be 6. The template 2101, 2102, and 2103 may be configured with neighboring blocks adjacent to the current block. The size of the template may be 2 W×6 (2102)+2H×6 (2103)+6×6 (2101). In FIG. 21-a, samples marked by horizontal slashes beyond a template area (dotted box, vertical slashes) may be side samples. FIG. 21-b illustrates a current block and neighboring samples of the current block. FIG. 21-c illustrates a convolutional relation for calculating a prediction value of the current block.

Referring to FIG. 21-b and FIG. 21-c, a prediction value of the current block may be calculated based on the current block and the neighboring samples of the current block. Referring to FIG. 21-b, the neighboring samples of the current block may be five neighboring samples disposed in the form of a cross around the current block. C is a sample located in the center of the current block, N denotes a sample located in the upper side of the current block, S denotes a sample located in the lower side of the current block, W denote a sample on the left of the current block, and E denotes a sample on the right of the current block. The prediction value of the current block may be calculated by using all or some of the coefficients of the neighboring samples. In this instance, the prediction value of the current block may be different for each color component (i.e., a luma component, a Cb component, a Cr component). In the same manner, convolutional filter coefficients may be different for each color component. For example, the number of convolutional filter coefficients may be 7 (C0, C1, C2, C3, C4, C5, C6). In this instance, the filter coefficients may be configured with coefficients (C0, C1, C2, C3, C4) of neighboring samples of the current block, a coefficient (C5) of a single non-linear element (P), and a coefficient (C6) of a single bias element (B). When calculating a convolutional filter coefficient, there may be the case in which neighboring samples (template) of the current block for the corresponding coefficient are not present. In this instance, samples in locations that are not present may have the same value as the value of the sample located in the center of the current block. That is, they may be padded with the value of the sample located in the center of the current block. For example, referring to FIG. 21-a, the samples of S and E of FIG. 21-b may not be present. In this instance, for convolutional filter coefficients (C2 and C3) corresponding to S and E, the values of S and E may be the same as the value of the sample (C) located in the center of the current block. The template may be configured for each color component. In the case in which a luma sample and a chroma sample are present in the same ratio, the templates may be in the same size and shape. In the case in which they are present in different ratios, the templates may be in different sizes and shapes.

Hereinafter, a method of calculating the non-linear element (P) of FIG. 21-C for each color component will be described. bitDepth denotes the bit-depth of an input sample, and may be a positive integer value. For example, the value of bitDepth may be 8, 10, 12, and the like.

The non-linear element (P) may be determined based on the value of the sample (C) located in the center of the current block. CLuma denotes the value of C when the current block is a luma component block. CCb denotes the value of C when the current block is a Cb component block. CCr denotes the value of C when the current block is a CR component block.

$$P = ( CLuma * CLuma + 1 ≪ ( bitDepth - 1 ) ) ≫ bitDepth \\ P = ( CCb * CCb + 1 ≪ ( bitDepth - 1 ) ) ≫ bitDepth \\ P = ( CCr * CCr + 1 ≪ ( bitDepth - 1 ) ) ≫ bitDepth$$

The non-linear element (P) may be determined based on the mean value (meanSamples) of all sample values of a reference block and/or all sample values of the current block. P may be calculated for each color component of the reference block and/or the current block. meanSamplesLuma denotes the mean value of all sample values when the reference block and/or the current block is a luma component block. meanSamplesCb denotes the mean value of all sample values when the reference block and/or the current block is a Cb component block. meanSamplesCr denotes the mean value of all sample values when the reference block and/or the current block is a Cr component block.

$$P = ( meanSamplesLuma * meanSamplesLuma + 1 ≪ ( bitDepth - 1 ) ) ≫ bitDepth \\ P = ( meanSamplesCb * meanSamplesCb + 1 ≪ ( bitDepth - 1 ) ) ≫ bitDepth \\ P = ( meanSamplesCr * meanSamplesCr + 1 ≪ ( bitDepth - 1 ) ) ≫ bitDepth$$

The non-linear element (P) may be determined based on a mean value for each color component of a template. meanY denotes the mean value of a template of a luma component block. meanCb denotes the mean value of a template of a Cb component block. meanCr denotes the mean value of a template of a Cr component block. In this instance, the template may be the template of the reference block and/or the template of the current block.

$$P = ( meanY * meanY + 1 ≪ ( bitDepth - 1 ) ) ≫ bitDepth , \\ P = ( meanCb * meanCb + 1 ≪ ( bitDepth - 1 ) ) ≫ bitDepth , \\ P = ( meanCr * meanCr + 1 ≪ ( bitDepth - 1 ) ) ≫ bitDepth$$

The bit operators << and >> in the equation are left/right shift operators, and may indicate results of multiplication and division.

The bias element (B) is an integer value and may have the median value of bitDepth. For example, in the case in which bitDepth is 10 bits, B may be 512.

FIGS. 22-a and 22-b are diagrams illustrating templates for a filter coefficient of a convolutional model according to an embodiment of the disclosure.

Referring to FIG. 22-a, a template may be configured with upper side neighboring samples and left side neighboring samples of a current coding/prediction block. A template of the current block and a template of a reference block may correspond to each other. That is, the size and the location of the template of the current block may be the same as the size and the location of the template of the reference block. In the case in which the template of the current block is configured with the upper side neighboring samples and the left side neighboring samples of the current block, the template of the reference block may be configured with the upper side samples and left side samples of the reference block. The template of the current block and the template of the reference block may have the same size. The size of the upper side neighboring samples may be width (W) of the current block×n, and the size of the left side neighboring samples may be n×height (H) of the current block. n may be an integer number greater than or equal to 1. In this instance, the template of the current block may additionally include top-left side neighboring samples 2203, when needed. In this instance, the size of the top-left side neighboring samples 2203 may be 6×6. Whether to use a side sample may be determine based on the form of a convolutional filter coefficient.

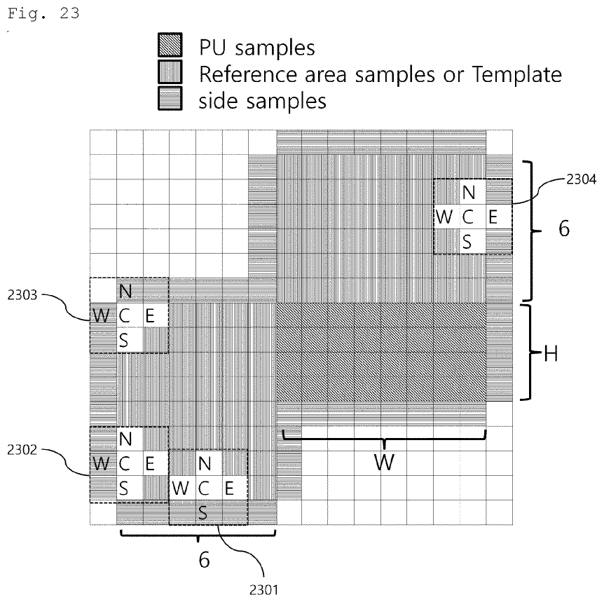

FIG. 23 is a diagram illustrating a method of applying a filter coefficient of a convolutional model and a padding method.

A neighboring sample in a predetermined location may be a sample (i.e., a side sample) that is not included in a template. In this instance, the side sample may be a predetermined value. The side sample may have the value same as one of the neighboring samples included in the template. That is, the side sample may be obtained by padding one of the neighboring samples included in the template. The side sample may be obtained by padding a sample closest to the side sample among the neighboring samples included in the template.

Alternatively, the side sample may have the mean value of a plurality of neighboring samples included in Depending on the location of the side the template. sample, a plurality of neighboring samples used for calculating a mean value may be determined. There may be a single set 2301, 2302, 2303, or 2304 including a calculated side sample and neighboring samples. In this instance, the mean value of neighboring samples included in a line closest to the side sample may be the value of the side sample. For example, referring to diagram 2301, a side sample may be S, and S may have the mean value of W, C, and E. Referring to diagram 2302, a side sample may be W, and W may have the mean value of N, C, and S. Referring to diagram 2303, side samples may be W and N, and W and N may have the mean value of C, E and S. Referring to diagram 2304, a side sample may be E, and E may have the mean value of N, C, and S. Alternatively, the mean value of the samples remaining after excluding a side sample in a set may be the value of the side sample.

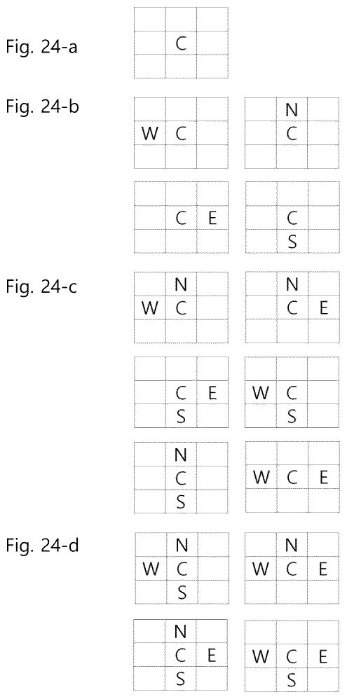

FIGS. 24-a to 24-d are diagrams illustrating the forms of a filter of a convolutional model according to an embodiment of the disclosure.

Referring to FIG. 24, the number of convolutional filter coefficients that has been described with reference to FIG. 21-C may be determined based on the form of a filter of a convolutional model. A filter form may be the form of the location of a calculated side sample and neighboring samples included in a single set that has been described with reference to FIG. 23.

Referring to FIG. 24-a, a neighboring sample that corresponds to a convolutional model filter coefficient may be 1 (C). Referring to FIG. 24-b, the number of neighboring samples corresponding to a convolutional model filter coefficient is 2, and the neighboring samples may be configured in three methods (W and C, N and C, C and E, or C and S). Referring to FIG. 24-c, the number of neighboring samples corresponding to a convolutional model filter coefficient is 3, and the neighboring samples may be configured in six methods (N, C, and W, N, C, and E, E, C, and S, W, C, and S, N, C, and S, or W, C, and E). Referring to FIG. 24-d, the number of neighboring samples corresponding to a convolutional model filter coefficient is 4, and the neighboring samples may be configured in four methods (N, W, S, and C, W, N, E, and C, N, E, S, and C, or W, S, E, and C).

A convolutional model relation may be changed based on the number of configured samples. Whether each of C, N, S, E, and W is present among neighboring samples, the filter coefficient may be number of a convolutional Whether a changed. a side sample for calculating convolutional model filter coefficient is needed may be determined based on the locations and the number of the neighboring samples. For example, in the case in which only the sample in location C is used as shown in FIG. 24-a, a side sample may not be needed. In the case in which samples in the locations W and C are used as shown in FIG. 24-b, a side sample in location W may be needed. That is, a side sample in location S in diagram 2301 and a side sample in location N in diagram 2303 may not be needed.

Each side sample W, N, E, and S may be padded with the value of a sample in location C, as shown in FIG. 24-b. As shown in FIG. 24-c, in the case in which the number of neighboring samples corresponding to a convolutional model filter coefficient is 3, the number of side samples may be 1 or 2. In this instance, in the case in which the number of side samples is 1, the side sample may be padded with the mean value of the two samples remaining after excluding the side sample. In the case in which the number of side samples is 2, the value of the sample remaining after excluding the side samples may be a side sample value. As shown in FIG. 24-d, in the case in which the number of neighboring samples corresponding to a convolutional model filter coefficient is 4, the number of side samples may be 1 or 2. In this instance, in the case in which the number of side samples is 1, the side sample may be padded with the mean value of the three samples remaining after excluding the side sample. In this instance, in the case in which the number of side samples is 2, the side samples may be padded with the mean value of the two samples remaining after excluding the side samples.

An optimal filter form may be a predetermined form. In this instance, a decoder may produce information associated with a filter form by including the same in a bitstream. In this instance, the information associated with a filter form may be included in header information of at least one of an SPS, a PPS, a PH, a slice/tile, and a coding unit. The decoder may parse the information associated with a filter form, so as to determine a filter form for predicting a current block. In the case in which information associated with a filter form is not included in a bitstream, a predetermined filter form may be used. In this instance, the predetermined filter form may be the form illustrated in FIG. 21-b.

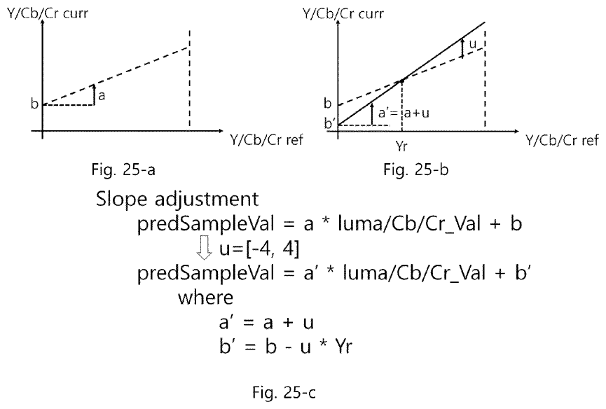

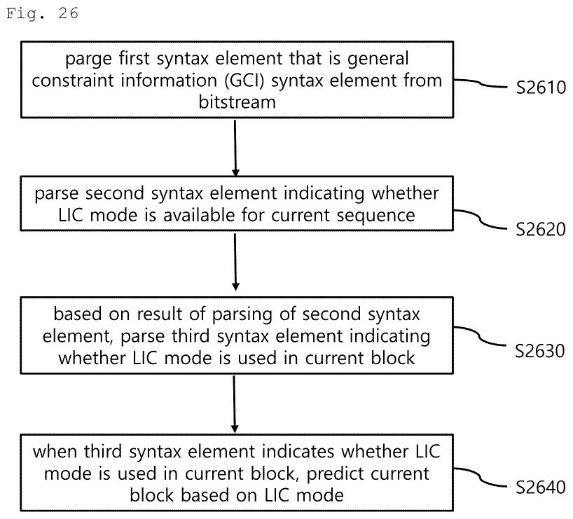

FIGS. 25-a and 25-b are diagrams illustrating a method of updating an LIC linear model.

An LIC linear model that has been described with reference to Equation 1 may be updated. In Equation 1, a which is the gradient and b which is the y-intercept may be updated as shown in Equation 3. That is a′ calculated via Equation 3 may be updated with a in Equation 1, and b′ may be updated with b in Equation 1.

$${a}^{′} = a + u , \\ {b}^{′} = b - u * Yr \qquad [ Equation 3 ]$$

In Equation 3, u may be a value signaled for each coding unit or each prediction unit. In this instance, u may have an integer value ranging from −4 to 4. Yr in Equation 3 may be the mean value of a template of a reference block. In this instance, updating may be performed for each color component. Therefore, in the case in which the template of the reference block corresponds to a luma component block, Yr may be the mean value of luma component blocks. In the case in which the template of the reference block corresponds to a Cb component block, Yr may be the mean value of Cb component blocks. In the case in which the template of the reference block corresponds to a Cr component block, Yr may be the mean value of Cr component blocks. In addition, Yr may be the mean value for each color component of a template of a current coding/prediction block, as opposed to the mean value for each color component of the template of the reference block. Yr may be the mean value of blocks of any one color component. That is, the mean value of blocks of any one component may be the mean value of blocks of the remaining color components.

FIG. 25-a illustrates Equation 1 in the form of a graph, and FIG. 25-b illustrates Equation 3 in the form of a graph.

The opposite of the relation between the horizontal axis (x-axis) and the vertical axis (y-axis) in FIG. 25-a and FIG. 25-b may be available. That is, Yr may be a mean value for each color component of a template of a current coding/prediction block or may be a mean value for any one color component. The value of u may be obtained based on a coding unit or prediction unit. That is, in the case in which an LIC flag value in coding units/prediction units is true, the u value may be signaled/parsed. The value of u may be a single value and may be the same for all color components, or may be different for each color component. In the case in which the value of u is not signaled, the value of u may be inferred to be 0.

FIG. 26 is a flowchart illustrating a method of predicting a current block according to an embodiment of the disclosure.

FIG. 26 illustrates a method of predicting a current block by using the methods that have been described with reference to FIGS. 1 to 25.

A decoder may parse a first syntax element that is a general constraint information (GCI) syntax element in operation S2610. The decoder may parse a second syntax element indicating whether an LIC mode is available for a current sequence in operation S2620. Based on a result of parsing the second syntax element, the decoder may parse a third syntax element indicating whether the LIC mode is used in the current block in operation S2630. When the third syntax element indicates whether the LIC mode is used in the current block, the decoder may predict the current block based on the LIC mode in operation S2640.

The first syntax element may be included in at least one of a sequence parameter set (SPS) RBSP syntax and a video parameter set (VPS) RBSP syntax, and the second syntax element may be included in the SPS RBSP syntax.

When the value of the first syntax element is 1, the value of the second syntax element is set to 0 that is a value indicating that the LIC mode is not used, irrespective of the result of parsing the second syntax element. When the value of the first syntax element is 0, the value of the second syntax element is not constrained.

The third syntax element may be parsed when the second syntax element indicates that the LIC mode is available for the current block.

The third syntax element may be parsed by additionally taking into consideration at least one of the number of samples of the current block, an encoding mode of the current block, and a prediction direction associated with the current block. Specifically, the third syntax element may be parsed when the number of samples of the current block is 32 or more. The third syntax element may be parsed when the encoding mode of the current block is not a merge mode, an IBC mode, and a CIIP mode. The third syntax element may be parsed when the prediction direction associated with the coding block is not bi-prediction.

The third syntax element may indicate whether the LIC mode is used in the current block. In this instance, the decoder may configure a first template including neighboring blocks of the current block. The decoder may configure a second template including neighboring blocks of a reference block of the current block. The decoder may obtain an LIC linear model based on the first template and the second template. The decoder may predict the current block based on the LIC linear model. A location and a size of the first template correspond to a location and a size of the second template.

The first template may include upper side neighboring blocks of the current block, and the second template may include upper side neighboring blocks of the reference block.

The first template may include left side neighboring blocks of the current block, and the second template may include left side neighboring blocks of the reference block.

The first template may include upper side neighboring blocks of the current block and left side neighboring blocks of the current block, and the second template may include upper side neighboring blocks of the reference block and left side neighboring blocks of the reference block.

When the encoding mode of the current block is a GPM mode, and the third syntax element indicates whether the LIC mode is used in the current block, the current block may be divided into a first area and a second area. In this instance, the decoder may obtain a first LIC linear model for the first area. The decoder may obtain, based on the first LIC linear model, a first prediction block for the first area. The decoder may obtain a second LIC linear model for the second area. The decoder may obtain, based on the second LIC linear model, a second prediction block for the second area. Based on the first prediction block and the second prediction block, the decoder may predict the current block.

The third syntax element may indicate whether the LIC mode is used in the current block. In this instance, the decoder may configure a template including neighboring blocks located in a predetermined range from the current block. Based on the template, the decoder may obtain a convolutional model. Based on the convolutional model, the decoder may predict the current block. The current block may be one sample. A filter coefficient of the convolutional model may be a coefficient of at least one sample among an upper side sample, a lower side sample, a left side sample, and a right side sample of the one sample. When one or more samples among the upper side sample, the lower side sample, the left side sample, and the right side sample of the one sample are not included in the template, a value of the sample that is not included in the template may be the mean value of the samples remaining after excluding the sample that is not included in the template. When one or more samples among the upper side sample, the lower side sample, the left side sample, and the right side sample of the one sample are not included in the template, the value of the sample that is not included in the template is identical to a value of a sample closest to the sample that is not included in the template, among the samples included in the template.

The above methods (video signal processing methods) described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1-20. (canceled)

21. A device for decoding a video signal, the device comprising a processor,
wherein the processor is configured to:
configure a first template including neighboring blocks of a current block,
configure a second template including neighboring blocks of a reference block of the current block,
obtain a convolutional model based on the first template and the second template, predict the current block based on the convolutional model.

22. The device of claim 21,
wherein a first color component of samples of the first template and a second color component of samples of the second template for the convolutional model are the same.

23. The device of claim 22,
wherein the first color component and the second color component are a luma component.

24. The device of claim 21,
wherein a filter coefficient of the convolutional model is a coefficient for at least one sample among a upper sample, a lower sample, a left sample, or a right sample of a first sample of the current block.

25. The device of claim 24,
when one or more the upper sample, the lower sample, the left sample, the right sample of the first sample is not included in the first template,
a value of the sample not included in the first template is the same as a value of a sample closet to a sample not included in the first template among samples included in the first template.

26. The device of claim 21,
wherein the reference block is a block that is temporally or spatially distant from the current block.

27. The device of claim 21,
wherein a size of the first template and a size of the second template are the same.

28. The device of claim 27,
wherein the size of the first template and the size of the second template are a pre-determined size.

29. The device of claim 28,
wherein the pre-determined size is in an integer sample unit.

30. The device of claim 24,
wherein the filter coefficient of the convolutional model is a value that minimizes a mean square error (MSE) between samples in the first template and samples in the second template.

31. A device for encoding a video signal, the device comprising a processor,
wherein the processor is configured to:
obtain a bitstream to be decoded by a decoder using a decoding method,
wherein the decoding method comprising:
configuring a first template including neighboring blocks of a current block,
configuring a second template including neighboring blocks of a reference block of the current block,
obtaining a convolutional model based on the first template and the second template,
predicting the current block based on the convolutional model.

32. The device of claim 31,
wherein a first color component of samples of the first template and a second color component of samples of the second template for the convolutional model are the same.

33. The device of claim 32,
wherein the first color component and the second color component are a luma component.

34. The device of claim 31,
wherein a filter coefficient of the convolutional model is a coefficient for at least one sample among a upper sample, a lower sample, a left sample, or a right sample of a first sample of the current block.

35. The device of claim 34,
when one or more the upper sample, the lower sample, the left sample, the right sample of the first sample is not included in the first template,
a value of the sample not included in the first template is the same as a value of a sample closet to a sample not included in the first template among samples included in the first template.

36. The device of claim 31,
wherein the reference block is a block that is temporally or spatially distant from the current block.

37. The device of claim 31,
wherein a size of the first template and a size of the second template are the same.

38. The device of claim 37,
wherein the size of the first template and the size of the second template are a pre-determined size,
wherein the pre-determined size is in an integer sample unit.

39. The device of claim 34,
wherein the filter coefficient of the convolutional model is a value that minimizes a mean square error (MSE) between samples in the first template and samples in the second template.

40. A non-transitory computer-readable medium storing a bitstream, the bitstream being decoded by a decoding method,
wherein the decoding method, comprising:
configuring a first template including neighboring blocks of a current block, configuring a second template including neighboring blocks of a reference block of the current block,
obtaining a convolutional model based on the first template and the second template,
predicting the current block based on the convolutional model.
